(19) United States
(12) Patent Application Publication
(10) Pub. No.: US 2015/0195033 A1
(43) Pub. Date: Jul. 9, 2015

(54) SELECTION OF COOPERATIVE STRATEGIES FOR RELAY NODES IN A WIRELESS NETWORK TO ENHANCE DATA THROUGHPUT

(71) Applicant: Telefonaktiebolaget L M Ericsson (publ), Stockholm (SE)

(72) Inventors: Ivana Maric, Sunnyvale, CA (US); Dennis Hui, Sunnyvale, CA (US)

(73) Assignee: Telefonaktiebolaget L M Ericsson (publ), Stockholm (SE)

(21) Appl. No.: 14/146,956

(22) Filed: Jan. 3, 2014

(51) Int. Cl. H04B 7/155; H04W 40/16; H04W 40/12

(52) U.S. Cl. CPC H04B 7/15592; H04W 40/12; H04W 40/16; H04W 84/18

(57) ABSTRACT

Systems and methods are disclosed for selecting cooperative strategies for relay nodes in a wireless network. In one embodiment, a cooperative strategy for a relay node in a wireless network is selected from a set of two or more cooperative strategies. The cooperative strategy defines a manner in which the relay node relays messages along a multi-hop route through the wireless network. Use of the cooperative strategy by the relay node is then effected. In one embodiment, the cooperative strategy is selected based on one or more channel quality based criteria. By selecting the cooperative strategy for the relay node, and in one preferred embodiment selecting cooperative strategies for all other relay nodes in the multi-hop route, performance of the wireless network can be improved.

### FIELD OF THE DISCLOSURE

The present disclosure relates to a wireless network and, in particular, to enhancing data throughput over a multi-hop route through a wireless network.

### BACKGROUND

To cope with the exponential growth in wireless data traffic in cellular communications networks, it is anticipated that substantially denser deployment of wireless access nodes (e.g., base stations) will be required in the future. The feasibility of a very dense deployment of wireless access nodes is predicated on the existence of a backhaul network that can provide high-data-rate transport for each individual access node in the cellular communications network. From the point of view of maximizing capacity, optical-fiber-based backhaul solutions are probably the most desirable ones and are most suitable for new constructions. However, in existing buildings and infrastructure, the cost of installation of new fibers to every wireless access node in a very dense network can be prohibitive.

One alternative is a wireless self-backhaul solution, where the same access spectrum is used to provide backhaul transport. With self-backhauling, a wireless access node serves not only its own assigned User Equipment devices (UEs) that are in its vicinity but also its neighboring access nodes as a relaying node in order to transfer data towards and/or from an information aggregation node that connects the wireless network to the cellular communications network. A group of self-backhauling access nodes can form a multi-hop mesh network. Access nodes cooperatively transfer each other's traffic to and from the aggregation node.

A common approach to transfer data in a multi-hop wireless network is via Store-and-Forward (SF), also commonly referred to as routing. In SF, data is transmitted from a source node to a destination node through relay nodes positioned on a predetermined route. Each node on the route receives data only from its immediate predecessor and forwards the received data to the next node on the route. All other signals are treated as noise. The network performance (e.g., data throughput, energy efficiency, reliability) can be significantly improved by deploying more advanced cooperative strategies, including: Decode-and-Forward (DF) (see, for example, Thomas M. Cover et al., “Capacity Theorems for the Relay Channel,” IEEE Transactions on Information Theory, Vol. IT-25, No. 5, September 1979, pages 572-584, (hereinafter “Cover”)), Compress-and-Forward (CF) (see, for example, Cover), Noisy Network Coding (NNC) (see, for example, Sung Hoon Lim et al., “Noisy Network Coding,” IEEE Transactions on Information Theory, Vol. 57, No. 5, May 2011, pages 3132-3152 (hereinafter “Lim”)), and Short Message Noisy Network Coding (SNNC) (see, for example, Jie Hou et al., “Short Message Noisy Network Coding with a Decode-Forward Option,” submitted to IEEE Transactions on Information Theory, August 2013 (hereinafter “Hou”)). While DF outperforms SF, DF shares the requirement of SF that each relay node on the route must decode the transmitted data. This requirement can drastically decrease the transmission rate if the link over which a relay node is receiving data is weak. Conversely, CF, NNC, and SNNC do not require the relay node to decode the transmitted data. Instead, the relay node compresses the received signal and forwards the obtained compression index, or information about the index. It has recently been shown in the literature that NNC and SNNC can bring wireless network performance close to its capacity (see, for example, Lim, Hou, and A. Salman Avestimehr et al., “Wireless Network Information Flow: A Deterministic Approach,” IEEE Transactions on Information Theory, Vol. 57, No. 4, April 2011, pages 1872-1905 (hereinafter “Avestimehr”)). The drawback of these compression schemes, unlike DF, is that the compression noise is accumulated and propagated in the network, which in turn decreases the performance of the network.

As such, there is a need for systems and methods for optimizing the performance (e.g., data throughput) of a multi-hop wireless network.

### SUMMARY

The present disclosure relates to selecting cooperative strategies for relay nodes in a wireless network. In one embodiment, a cooperative strategy for a relay node in a wireless network is selected from a set of two or more cooperative strategies. The cooperative strategy defines a manner in which the relay node relays messages along a multi-hop route through the wireless network. Use of the cooperative strategy by the relay node is then effected (i.e., the relay node uses or is caused to use the cooperative strategy). In one embodiment, the cooperative strategy is selected based on one or more channel quality based criteria. By selecting the cooperative strategy for the relay node, and in one preferred embodiment selecting cooperative strategies for all other relay nodes in the multi-hop route, performance of the wireless network can be improved.

In one embodiment, the cooperative strategy is selected based on a data rate based criterion. In one particular embodiment, selecting the cooperative strategy based on the data rate based criterion includes selecting one of the set of two or more cooperative strategies for the relay node that provides a highest end-to-end data rate for the multi-hop route. In another particular embodiment, the two or more cooperative strategies include a first cooperative strategy that requires decoding of received messages and a second cooperative strategy that does not require decoding of received messages, and selecting the cooperative strategy from the set of two or more cooperative strategies based on the data rate based criterion includes determining a first end-to-end data rate for the multi-hop route assuming the first cooperative strategy for the relay node, determining a second end-to-end data rate for the multi-hop route assuming the second cooperative strategy for the relay node, selecting the first cooperative strategy as the cooperative strategy for the relay node if the first end-to-end data rate is greater than the second end-to-end data rate, and selecting the second cooperative strategy as the cooperative strategy for the relay node if the first end-to-end data rate is less than the second end-to-end data rate. In one embodiment, the first cooperative strategy is a Decode-and-Forward (DF) cooperative strategy, and the second cooperative strategy is either a Compress-and-Forward (CF) cooperative strategy or a Short Message Noisy Network Coding (SNNC) cooperative strategy.

In another embodiment, the cooperative strategy is selected based on a Signal-to-Interference plus Noise Ratio (SINR) based criterion. In one embodiment, the two or more cooperative strategies include a first cooperative strategy that requires decoding of received messages and a second cooperative strategy that does not require decoding of received messages, and selecting the cooperative strategy from the set of two or more cooperative strategies based on the SINR based criterion includes determining a first SINR value for an incoming wireless link to the relay node from a nearest upstream wireless network node in the multi-hop route that is utilizing the first cooperative strategy, determining a second SINR value for an outgoing wireless link from the relay node to an immediate downstream wireless network node in the multi-hop route, selecting the first cooperative strategy as the cooperative strategy for the relay node if a ratio of the first SINR value and the second SINR value is greater than a predefined threshold, and selecting the second cooperative strategy as the cooperative strategy for the relay node if the ratio of the first SINR value and the second SINR value is less than the predefined threshold.

In one embodiment, the two or more cooperative strategies include a first cooperative strategy that requires decoding of received messages and a second cooperative strategy that does not require decoding of received messages. Further, in one embodiment, the first cooperative strategy is a DF cooperative strategy and the second cooperative strategy is either a CF cooperative strategy or a SNNC cooperative strategy. In one embodiment, a signal quality for an incoming wireless link to the relay node is determined, and selecting the cooperative strategy for the relay node includes selecting the first cooperative strategy if the signal quality is better than a predefined threshold signal quality and selecting the second cooperative strategy if the signal quality is worse than the predefined threshold signal quality.

In one embodiment, the wireless network is a wireless mesh network. Further, in one embodiment, the wireless mesh network is a backhaul network between multiple access nodes of a cellular communications network, and the relay node is one of the access nodes.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a wireless network according to one embodiment of the present disclosure;

FIG. 2 illustrates one example of a multi-hop route through the wireless network of FIG. 1 according to one embodiment of the present disclosure;

FIG. 3 illustrates a process by which a node selects and effects use of a cooperative strategy for a relay node in a multi-hop route through the wireless network of FIG. 1 according to one embodiment of the present disclosure;

FIG. 4 illustrates a process by which the wireless network of FIG. 1 selects cooperative strategies for a number of relay nodes in a multi-hop route through the wireless network of FIG. 1 according to one embodiment of the present disclosure;

FIG. 5 illustrates a distributed process by which the wireless network of FIG. 1 selects cooperative strategies for a number of relay nodes in a multi-hop route according to a round-robin ordering scheme according to one embodiment of the present disclosure;

FIG. 6 illustrates a centralized process by which the wireless network of FIG. 1 selects cooperative strategies for a number of relay nodes in a multi-hop route according to a round-robin ordering scheme according to one embodiment of the present disclosure;

FIG. 7 illustrates a hybrid process by which the wireless network of FIG. 1 selects cooperative strategies for a number of relay nodes in a multi-hop route according to a round-robin ordering scheme according to one embodiment of the present disclosure;

FIG. 8 illustrates one example of a multi-hop route including relay nodes for which cooperative strategies can be selected according to the process of FIG. 5, 6, or 7 according to one embodiment of the present disclosure;

FIGS. 9A through 9D illustrate a distributed process by which the wireless network of FIG. 1 selects cooperative strategies for a number of relay nodes in a multi-hop route according to a bottleneck ordering scheme according to one embodiment of the present disclosure;

FIGS. 10A and 10B illustrate a centralized process by which the wireless network of FIG. 1 selects cooperative strategies for a number of relay nodes in a multi-hop route according to a bottleneck ordering scheme according to one embodiment of the present disclosure;

FIGS. 11A and 11B illustrate a hybrid process by which the wireless network of FIG. 1 selects cooperative strategies for a number of relay nodes in a multi-hop route according to a bottleneck ordering scheme according to one embodiment of the present disclosure;

FIG. 12 illustrates one example of a multi-hop route including relay nodes for which cooperative strategies can be selected according to the process of FIGS. 9A through 9D, FIGS. 10A and 10B, or FIGS. 11A and 11B according to one embodiment of the present disclosure;

FIGS. 13 and 14 illustrate a data rate improvement for one example of a multi-hop route through a wireless network where cooperative strategies for relay nodes in the multi-hop route are selected according to one embodiment of the present disclosure; and

FIG. 15 is a block diagram of one of the wireless network nodes in the wireless network of FIG. 1 according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

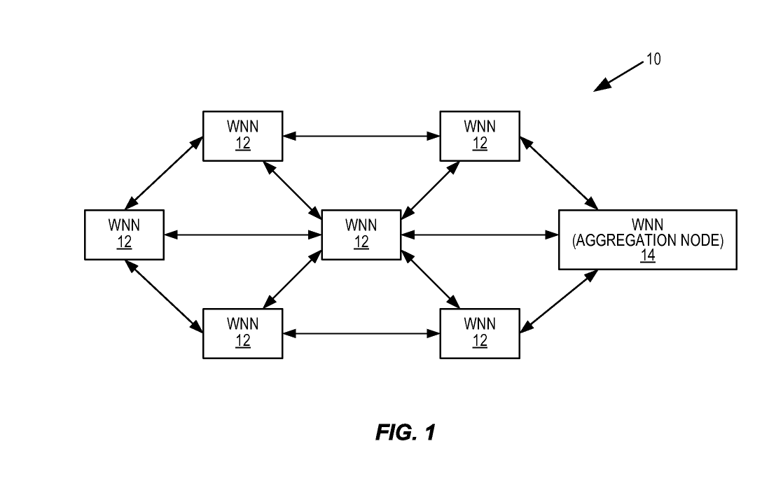

FIG. 1 illustrates a wireless network 10 according to one embodiment of the present disclosure. The wireless network 10 includes a number of wireless network nodes 12 and, in this embodiment, an aggregation node 14. In this embodiment, the wireless network nodes 12 are wireless access nodes, e.g., base stations such as small cell base stations, of a cellular communications network, and the aggregation node 14 is a wireless node that connects the wireless network 10 to a cellular communications network via a wired or wireless connection. The aggregation node 14 may also be a wireless access node. In this embodiment, the wireless network 10 is a wireless mesh network utilized by the wireless network nodes 12 for backhaul transport (i.e., the wireless network 10 is a wireless backhaul mesh network). Note, however, that the wireless network 10 is not limited to being a wireless backhaul mesh network. The concepts disclosed herein are applicable to any wireless network having a multi-hop route and, in particular, any wireless mesh network having a multi-hop route. While only a few wireless network nodes 12 are illustrated in the example of FIG. 1, the wireless network 10 may include any number, and potentially many, wireless network nodes 12 (e.g., in a dense deployment of small cell base stations).

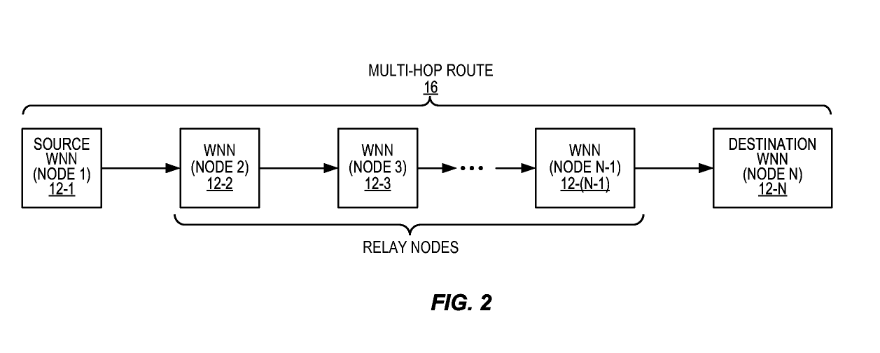

The wireless network 10 preferably includes multiple source-destination pairs, where routes between the source-destination pairs (at least some of which are multi-hop routes) have been established via, for example, an underlying routing algorithm. FIG. 2 illustrates one example of a multi-hop route 16 through the wireless network 10. As illustrated, the multi-hop route 16 includes a number of wireless network nodes 12-1 through 12-N. The wireless network node 12-1 is a source (i.e., node 1) for the multi-hop route 16 and is therefore also referred to herein as the source wireless network node 12-1. The wireless network node 12-N is a destination (i.e., node N) for the multi-hop route 16 and is therefore also referred to herein as the destination wireless network node 12-N. The wireless network nodes 12-2 through 12-(N−1) are relay nodes, which are also referred to herein as node 2 through node N−1.

A common approach to transfer data over a multi-hop route, such as the multi-hop route 16, is via Store-and-Forward (SF), also commonly referred to as routing. In SF, data is transmitted from the source wireless network node 12-1 to the destination wireless network node 12-N through the relay nodes (i.e., the wireless network nodes 12-2 through 12-(N-1)) positioned on the predetermined multi-hop route 16. Each relay node in the multi-hop route 16 receives data only from its immediate upstream node (i.e., the immediate predecessor in the multi-hop route 16), and forwards the data to the immediate downstream node (i.e., the immediate successor in the multi-hop route 16). All other signals are treated as noise. The network performance (e.g., data throughput, energy efficiency, and reliability) can be significantly improved by deploying more advanced cooperative strategies including, for example: Decode-and-Forward (DF), Compress-and-Forward (CF), Noisy Network Coding (NNC), and Short Message Noisy Network Coding (SNNC). While DF outperforms SF, DF shares the requirement of SF that each relay node in the multi-hop route 16 must decode the transmitted data. This requirement can drastically decrease the transmission rate if the link over which a relay node is receiving data is weak. Conversely, CF, NNC, and SNNC do not require the relay node to decode the transmitted data. Instead, the relay node compresses the received signal and forwards the obtained compression index, or information about the index.

It has recently been shown in the literature that NNC and SNNC can bring wireless network performance close to its capacity. The drawback of these cooperative schemes, unlike DF, is that the compression noise is accumulated and propagated along the multi-hop route 16. In contrast, DF does not suffer from this problem because noise is cleared out at every relay node via decoding. Thus, decoding-based and compression-based cooperative strategies have complementary advantages (and drawbacks). The embodiments described below enable selection of cooperative strategies for the relay nodes in the multi-hop route 16 to enable use of a combination of decoding-based and compression-based cooperative strategies along the multi-hop route 16 that maximizes, or at least improves, the performance of the wireless network 10. When applied together, the decoding-based and compression-based cooperative strategies can fully adapt to network topology and channel conditions and take full advantage of both strategies to thereby maximize, or at least improve, the network performance.

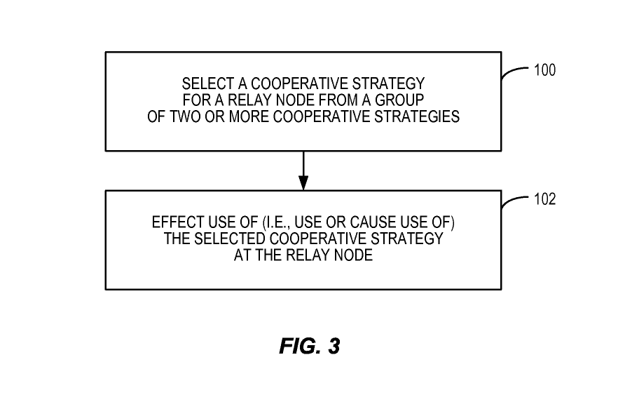

In this regard, FIG. 3 illustrates a process by which a cooperative strategy for a relay node in the multi-hop route 16 through the wireless network 10 is selected according to one embodiment of the present disclosure. This process is preferably performed for each relay node in the multi-hop route 16 to provide a combination of cooperative strategies for the relay nodes in the multi-hop route 16 that maximizes, or at least improves, performance (e.g., data throughput). First, a cooperative strategy for the relay node is selected from a group, or set, of two or more cooperative strategies (step 100). As used herein, a cooperative strategy defines a manner in which the relay node relays messages in the multi-hop route 16. In one embodiment, the set of cooperative strategies includes a decoding-based cooperative strategy (e.g., DF) and a compression-based cooperative strategy (e.g., CF or SNNC). Further, while the set of cooperative strategies includes only two cooperative strategies in this embodiment, the set may include any number of two or more cooperative strategies. Note that a decoder at a wireless network node 12 that is decoding data sent by SNNC can use different decoding schemes, namely backward decoding, joint decoding, or sliding-window decoding. The choice of decoding scheme does not affect the cooperative strategy selection schemes disclosed herein.

In one embodiment, the cooperative strategy for the relay node is selected based on one or more channel quality based criteria (e.g., received signal strength). More specifically, the decoding-based cooperative strategy (e.g., DF) is selected for the relay node if the channel quality (e.g., received signal strength) for an incoming wireless link from a transmitting wireless network node 12 (i.e., the upstream wireless network node 12 transmitting the data to be relayed, which can be the source wireless network node 12-1 or another relay node) is strong (i.e., greater than a predefined threshold). This is typically the case when the relay node is close to the transmitting node. Conversely, the compression-based cooperative strategy (e.g., CF or SNNC) is selected for the relay node if the channel quality (e.g., received signal strength) for the incoming wireless link is weak (i.e., less than a predefined threshold which may be the same as or less than the predefined threshold for determining if the incoming wireless link is strong). Further, the compression-based cooperative strategy may be selected for the relay node if a channel quality (e.g., received signal strength) for a wireless link from the relay node to its immediate downstream wireless network node 12 in the multi-hop route 16 (i.e., the receiving node) is strong. Note that the incoming/outgoing received signal strength for the relay node depends on the relative position of the relay node with respect to the transmitting node and the receiving node as well as fading conditions. By selecting the cooperative strategy for the relay node in this manner, rate reduction associated with the decoding-based cooperative strategy is avoided if the channel quality for the incoming wireless link to the relay node is poor (e.g., the incoming signal is weak). At the same time, quantization noise clean-up resulting from the decoding-based cooperative strategy is provided if the relay node is in a favorable position (e.g., high incoming channel quality).

In one embodiment, the one or more channel quality criteria include a data rate based criterion such that the cooperative strategy for the relay node is selected based on the rate-based criterion. More specifically, the data rate based criterion is based on end-to-end data rates for the multi-hop route 16 calculated or otherwise determined for the two or more cooperative strategies in the set. In general, for each cooperative strategy, an end-to-end data rate for the multi-hop route 16 is determined assuming the cooperative strategy is selected as the cooperative strategy for the relay node. Then, the cooperative strategy that provides the best end-to-end data rate is selected as the cooperative strategy for the relay node. For example, in one embodiment, the two or more cooperative strategies consist of the DF cooperative strategy and the SNNC cooperative strategy. The end-to-end data rate for the multi-hop route 16 assuming the DF cooperative strategy is selected for the relay node (denoted R_{DF}) is determined. Note that, initially, all relay nodes may be assumed to be operating according to some initial cooperative strategy, e.g., DF or SNNC. In addition, the end-to-end data rate for the multi-hop route 16 assuming the SNNC cooperative strategy selected for the relay node (denoted R_{SNNC}) is determined. If R_{DF}<R_{SNNC}, the SNNC cooperative strategy is selected for the relay node. Otherwise, if R_{DF}≧R_{SNNC}, the DF cooperative strategy is selected for the relay node.

In another embodiment, the one or more channel quality criteria include a Signal-to-Interference plus Noise Ratio (SINR) based criterion such that the cooperative strategy for the relay node is selected based on the SINR based criterion. More specifically, the SINR based criterion is based on a SINR of an incoming wireless link and/or an outgoing wireless link of the relay node. In one embodiment, the SINR based criterion is such that a decoding based cooperative strategy (e.g., DF) is selected for the relay node if the relay node is (roughly) closer to a nearest upstream node in the multi-hop route 16 that is using the decoding based cooperative strategy than its immediately downstream node in the multi-hop route 16. Otherwise, a compression based cooperative strategy (e.g., CF or SNNC) is selected for the relay node. For example, in one embodiment, the two or more cooperative strategies consist of the DF cooperative strategy and the SNNC cooperative strategy. Let the wireless network nodes 12 in the multi-hop route 16 be labeled as nodes 1, 2, . . . , j, N, where node 1 is the source wireless network node 12-1 and node N is the destination wireless network node 12-N. The relay node is node j, where 1<j<N. In this example, the SINR based criterion is defined such that, if

$$\frac{{SINR}_{i ( j ) , j}}{{SINR}_{j , j + 1}} < Th , \qquad ( 1 )$$

then the SNNC cooperative strategy is selected for the relay node. Otherwise, if

$$\frac{{SINR}_{i ( j ) , j}}{{SINR}_{j , j + 1}} \geq Th , \qquad ( 2 )$$

then the DF cooperative strategy is selected for the relay node. In Equations (1) and (2), i(j) denotes i(j)=max{k<j: node k performs DF}. Thus, i(j) is the closest preceding, or upstream, wireless network node 12 to the relay node (node j) in the multi-hop route 16 that performs DF (i.e., uses the DF cooperative strategy). If no upstream relay node performs DF, then i(j) is the source wireless network node 12-1 in which case the source does not perform DF, but transmits the data. SINR_{i(j),j} denotes received SINR from node i(j) to the relay node (node j), SINR_{j,j+1} denotes received SINR from the relay node (node j) to the immediate downstream node of the relay node in the multi-hop route 16 (node j+1), and Th denotes a SINR threshold. In one particular example, the SINR threshold Th is set to 0.6, but is not limited thereto.

Once the cooperative strategy is selected for the relay node, use of the selected cooperative strategy by the relay node when relaying messages along the multi-hop route 16 is effected (step 102). In one embodiment, the process of FIG. 3 is performed by the relay node in which case use of the selected cooperative strategy by the relay node is effected by simply using the selected cooperative strategy at the relay node when relaying messages along the multi-hop route 16. In another embodiment, the process of FIG. 3 is performed by a node other than the relay node, e.g., performed by a central node associated with the wireless network 10 such as, for example, the aggregation node 14. In this case, the central node may cause the relay node to use the selected cooperative strategy by sending a corresponding instruction or some other indication to the relay node.

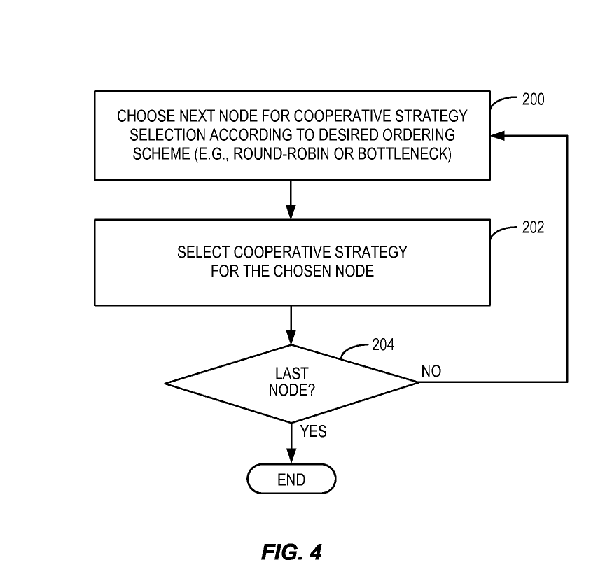

While FIG. 3 illustrates a process for selecting a cooperative strategy for a relay node, in one preferred embodiment, a cooperative strategy is selected for each relay node in the multi-hop route 16. In this regard, FIG. 4 is a flow chart that illustrates the operation of the wireless network 10 to select cooperative strategies for all of the relay nodes in the multi-hop route 16 according to one embodiment of the present disclosure. As illustrated, a next relay node for cooperative strategy selection is chosen from the relay nodes in the multi-hop route 16 according to a desired ordering scheme (step 200). The ordering scheme defines an order in which the relay nodes in the multi-hop route 16 are to be processed for cooperative strategy selection. In one embodiment, the ordering scheme is a round-robin ordering scheme such that the relay nodes are selected in the same order in which the relay nodes occur in the multi-hop route 16. In another embodiment, the ordering scheme is a bottleneck ordering scheme. In the bottleneck ordering scheme, one of the relay nodes that is a bottleneck with regards to the end-to-end data rate of the multi-hop route 16 is identified as a bottleneck node. A cooperative strategy is then selected for the bottleneck node. Then, taking into consideration the selected cooperative strategy for the bottleneck node, a new bottleneck node is identified, and the process is repeated. Note that the round-robin ordering scheme and the bottleneck ordering scheme are only examples. Other ordering schemes may be used.

Once the relay node for cooperative strategy selection has been chosen, a cooperative strategy for the relay node is selected (step 202). The selection of the cooperative strategy for the relay node may be performed in the same manner as described above with respect to FIG. 3. A determination is then made as to whether the relay node is the last relay node to be processed according to the desired ordering scheme (step 204). If not, the process returns to step 200 and is repeated until the last relay node is processed. Once the last relay node has been processed, the process ends. Note that the process of FIG. 4 may be performed in a distributed manner, a centralized manner, or a hybrid of the two.

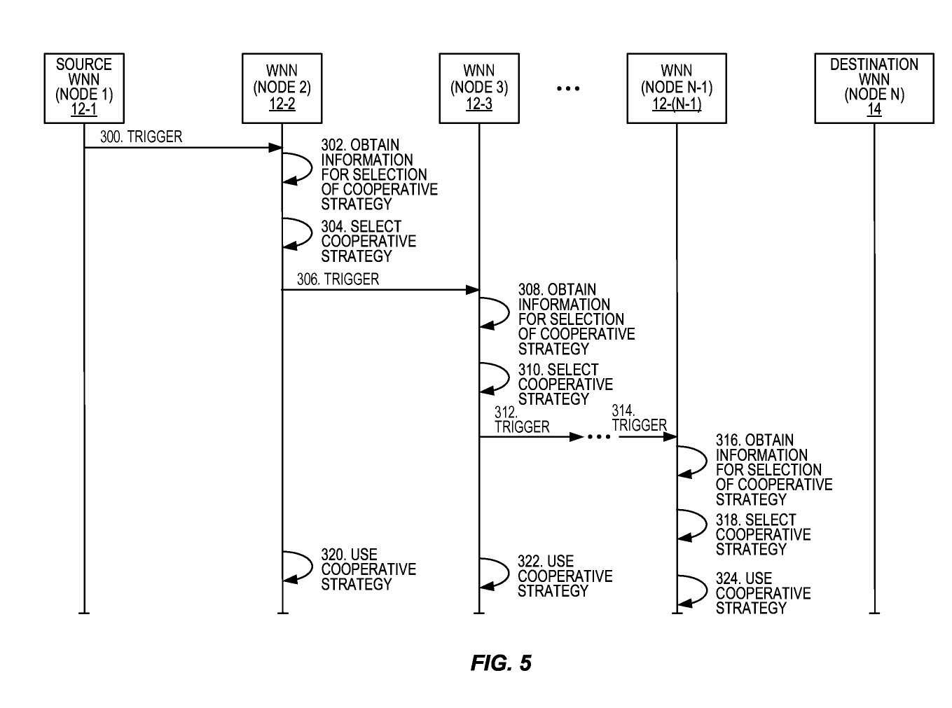

FIG. 5 illustrates the operation of the wireless network 10 to select cooperative strategies for the relay nodes in the multi-hop route 16 according to a round-robin ordering scheme using a distributed process according to one embodiment of the present disclosure. While not illustrated, the relay nodes may be initialized to a cooperative strategy (i.e., all relay nodes initialized to the same cooperative strategy) or initialized to a defined combination of cooperative strategies (i.e., at least some of the relay nodes are initialized to different cooperative strategies). In this embodiment, the process is triggered by the source wireless network node 12-1 sending a corresponding triggering message or information to the wireless network node 12-2, which is referred to as node 2 and is a first relay node in the multi-hop route 16 (step 300). In response, the wireless network node 12-2 obtains information for selection of a cooperative strategy for the wireless network node 12-2 (step 302) and selects a cooperative strategy for the wireless network node 12-2 based on the information (step 304). The wireless network node 12-2 may select the cooperative strategy for the wireless network node 12-2 in the manner described above with respect to FIG. 3.

The information obtained in step 302 is generally any information needed by the wireless network node 12-2 to make the selection. The information may be obtained locally at the wireless network node 12-2 (e.g., via one or more measurements) and/or obtained from other nodes (e.g., other wireless network nodes 12 and/or some other node(s) associated with the wireless network 10). As an example, if the selection is based on the rate-based criterion discussed above, the information includes the end-to-end data rates for the multi-hop route 16 for each potential cooperative strategy (e.g., R_{DF} assuming the DF cooperative strategy is selected for the wireless network node 12-2 and R_{SNNC} assuming that the SNNC cooperative strategy is selected for the wireless network node 12-2). Note that, in one embodiment, calculation of the end-to-end data rate uses SINR values at all receiving nodes in the multi-hop route 16, in which case appropriate control signaling can be used to provide the SINR values to the appropriate node(s).

As another example, if the selection is based on the SINR based criterion discussed above, the information includes the incoming SINR, outgoing SINR, and information that identifies at least the closest upstream wireless network node 12 that performs the DF cooperative strategy (i.e., node i(j) for j=2). If none of the upstream relay nodes perform DF, then node i(j) for j=2 is the source wireless network node 12-1. More specifically, the incoming SINR is SINR_{i(j),j} (for j=2) is measured by the wireless network node 12-2, the outgoing SINR is SINR_{j,j+1} (for j=2) is measured by the wireless network node 12-3 and directly or indirectly provided to the wireless network node 12-2, and the information that identifies the node i(j) (for j=2) may be sent from the wireless network node 12-1 to the wireless network node 12-2. Note that control signaling from node i(j) to node j enables node j to measure SINR_{i(j),j} (e.g., enables node j to listen for pilot signals or control packets sent from node i(j)).

Once the wireless network node 12-2 has selected its cooperative strategy, the wireless network node 12-2 triggers cooperative strategy selection by the wireless network node 12-3 (i.e., node 3 or the second relay node) (step 306). In one embodiment, in addition to the trigger or as (or as part of) the trigger, the wireless network node 12-2 sends information that identifies the cooperative strategy selected by the wireless network node 12-2. The wireless network node 12-3 then obtains information for selection of a cooperative strategy for the wireless network node 12-3 (step 308) and selects a cooperative strategy for the wireless network node 12-3 based on the information (step 310). The wireless network node 12-3 may select the cooperative strategy for the wireless network node 12-3 in the manner described above with respect to FIG. 3.

The information obtained in step 308 is generally any information needed by the wireless network node 12-3 to make the selection. The information may be obtained locally at the wireless network node 12-3 (e.g., via one or more measurements) and/or obtained from other nodes (e.g., other wireless network nodes 12 and/or some other node(s) associated with the wireless network 10). As an example, if the selection is based on the rate-based criterion discussed above, the information includes the end-to-end data rates for the multi-hop route 16 for each potential cooperative strategy (e.g., R_{DF} assuming the DF cooperative strategy is selected for the wireless network node 12-3 and R_{SNNC} assuming that the SNNC cooperative strategy is selected for the wireless network node 12-3). As another example, if the selection is based on the SINR based criterion discussed above, the information includes the incoming SINR, outgoing SINR, and information that identifies at least the closest upstream wireless network node 12 that performs DF (i.e., node i(j) for j=3). If none of the upstream relay nodes perform DF, then node i(j) for j=3 is the source wireless network node 12-1. More specifically, the incoming SINR is SINR_{i(j),j} (for j=3) is measured by the wireless network node 12-3, the outgoing SINR is SINR_{j,j+1} (for j=3) is measured by the wireless network node 12-4 (not shown) and directly or indirectly provided to the wireless network node 12-3, and the information that identifies the node i(j) (for j=3) may be sent from the wireless network node 12-2 to the wireless network node 12-3 as, as part of, or in association with the trigger of step 306.

Once the wireless network node 12-3 has selected its cooperative strategy, the wireless network node 12-3 triggers cooperative strategy selection by the wireless network node 12-4 (not shown) (step 312). The process continues in this manner until the wireless network node 12-(N-1) (i.e., node N−1) receives a trigger from its upstream node (i.e., wireless network node 12-(N−2)) (step 314). In response, the wireless network node 12-(N-1) then obtains information for selection of a cooperative strategy for the wireless network node 12-(N-1) (step 316) and selects a cooperative strategy for the wireless network node 12-(N-1) based on the information (step 318). The wireless network node 12-(N-1) may select the cooperative strategy for the wireless network node 12-(N-1) in the manner described above with respect to FIG. 3. Further, the information obtained in step 316 may be obtained by the wireless network node 12-(N-1) in the same manner as described above with respect to the wireless network nodes 12-2 and 12-3. Once the wireless network node 12-(N-1) has selected its cooperative strategy, all of the relay nodes have selected their cooperative strategies. The relay nodes use their cooperative strategies when relaying messages over the multi-hop route 16 (steps 320 through 324).

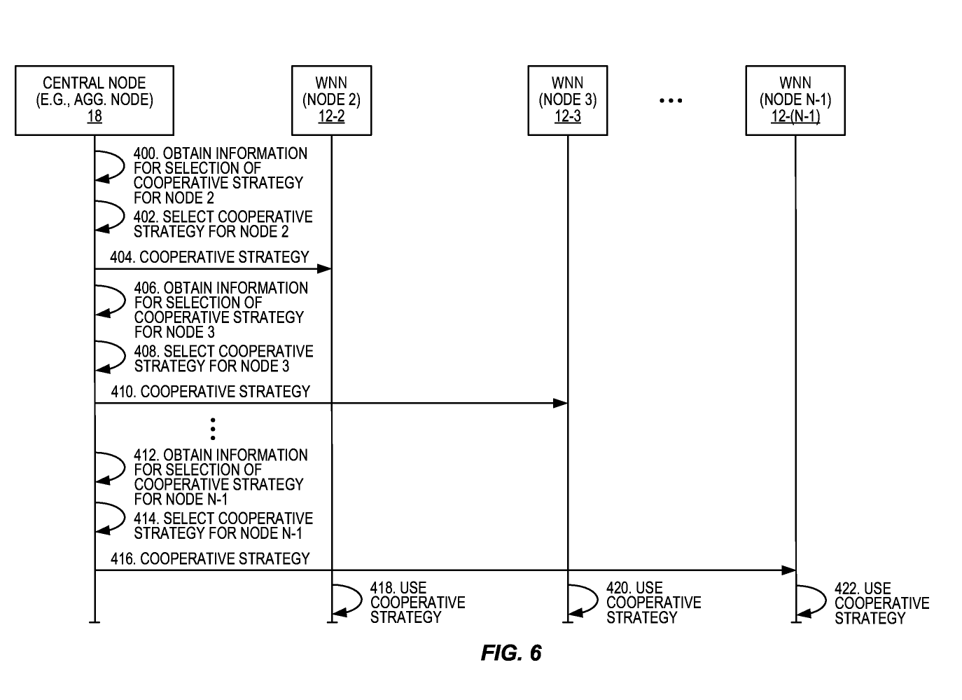

FIG. 6 illustrates a process similar to that of FIG. 5 but where the wireless network 10 operates to select cooperative strategies for the relay nodes in the multi-hop route 16 according to a round-robin ordering scheme using a centralized process according to one embodiment of the present disclosure. In this embodiment, the selection process is performed by a central node 18 in a centralized manner. The central node 18 may be any node associated with the wireless network 10 such as, for example, the aggregation node 14. The procedure is preferably (but not necessarily) initialized by assuming that all nodes perform SNNC (or CF). Different initializations (such as #1: all relays are assumed to initially perform DF; or, #2: it is assumed that, initially, a subset of relays performs DF and another subset performs SNNC) are also allowed. Given the initial cooperative strategy at each node, end-to-end rate can be calculated. For example, if it is assumed that all nodes initially perform SNNC, then end-to-end rate can be calculated as in, e.g., Sung Hoon Lim et al., “Noisy Network Coding,” IEEE Transactions on Information Theory, Vol. 57, No. 5, May 2011, pages 3132-3152. However, any suitable algorithm can be used to calculate the end-to-end rate. As illustrated, the central node 18 obtains information for selection of a cooperative strategy for the wireless network node 12-2 (step 400) and selects a cooperative strategy for the wireless network node 12-2 based on the information (step 402). The central node 18 may select the cooperative strategy for the wireless network node 12-2 in the manner described above with respect to FIG. 3.

The information obtained in step 400 is generally any information needed by the central node 18 to select the cooperative strategy for the wireless network node 12-2. The information may be obtained locally at the central node 18 and/or obtained from other nodes (e.g., one or more of the wireless network nodes 12). As an example, if the selection is based on the rate-based criterion discussed above, the information includes the end-to-end data rates for the multi-hop route 16 for each potential cooperative strategy (e.g., R_{DF} assuming the DF cooperative strategy is selected for the wireless network node 12-2 and R_{SNNC} assuming that the SNNC cooperative strategy is selected for the wireless network node 12-2). If the cooperative strategy at the wireless network node 12-2 is changed to DF, the end-to-end rate is modified accordingly to take this into account. As another example, if the selection is based on the SINR based criterion discussed above, the information includes the incoming SINR of the wireless network node 12-2, outgoing SINR of the wireless network node 12-2, and information that identifies at least the closest upstream wireless network node 12 that performs DF (i.e., node i(j) for j=2). If none of the upstream relay nodes perform DF, then node i(j) for j=2 is the source wireless network node 12-1. More specifically, the incoming SINR is SINR_{i(j),j} (for j=2), which is measured by the wireless network node 12-2, which may be provided to the central node 18 directly or indirectly from the wireless network node 12-2; the outgoing SINR is SINR_{j,j+1} (for j=2), which is measured by the wireless network node 12-3, which may be provided to the central node 18 directly or indirectly from the wireless network node 12-3; and the information that identifies the node i(j) (for j=2) may be maintained locally at the central node 18.

Once the central node 18 has selected the cooperative strategy for the wireless network node 12-2, the central node 18 sends an indication of the selected cooperative strategy to the wireless network node 12-2 (step 404). While FIG. 6 illustrates the central node 18 sending the indication directly to the wireless network node 12-2, the indication may alternatively be sent to the wireless network node 12-2 indirectly (i.e., via one or more other nodes).

Next, the central node 18 obtains information for selection of a cooperative strategy for the wireless network node 12-3 (step 406) and selects a cooperative strategy for the wireless network node 12-3 based on the information (step 408). The central node 18 may select the cooperative strategy for the wireless network node 12-3 in the manner described above with respect to FIG. 3. The information obtained in step 406 is generally any information needed by the central node 18 to select the cooperative strategy for the wireless network node 12-3. The information may be obtained locally at the central node 18 and/or obtained from other nodes (e.g., one or more of the wireless network nodes 12). As an example, if the selection is based on the rate-based criterion discussed above, the information includes the end-to-end data rates for the multi-hop route 16 for each potential cooperative strategy (e.g., R_{DF} assuming the DF cooperative strategy is selected for the wireless network node 12-3 and R_{SNNC} assuming that the SNNC cooperative strategy is selected for the wireless network node 12-3). If the cooperative strategy at the wireless network node 12-3 is changed to DF, the new end-to-end rate is modified accordingly to take this into account. As another example, if the selection is based on the SINR based criterion discussed above, the information includes the incoming SINR of the wireless network node 12-3, outgoing SINR of the wireless network node 12-3, and information that identifies at least the closest upstream wireless network node 12 that performs DF (i.e., node i(j) for j=3). If none of the upstream relay nodes perform DF, then node i(j) for j=3 is the source wireless network node 12-1. More specifically, the incoming SINR is SINR_{i(j),j} (for j=3), which is measured by the wireless network node 12-3, which may be provided to the central node 18 directly or indirectly from the wireless network node 12-3; the outgoing SINR is SINR_{j,j+1} (for j=3), which is measured by the wireless network node 12-4, which may be provided to the central node 18 directly or indirectly from the wireless network node 12-4; and the information that identifies the node i(j) (for j=3) may be maintained locally at the central node 18.

Once the central node 18 has selected the cooperative strategy for the wireless network node 12-3, the central node 18 sends an indication of the selected cooperative strategy to the wireless network node 12-3 (step 410). While FIG. 6 illustrates the central node 18 sending the indication directly to the wireless network node 12-3, the indication may alternatively be sent to the wireless network node 12-3 indirectly (i.e., via one or more other nodes). The process continues in this manner until the central node 18 obtains information for selection of a cooperative strategy for the wireless network node 12-(N-1) (step 412) and selects a cooperative strategy for the wireless network node 12-(N-1) based on the information (step 414). The central node 18 may select the cooperative strategy for the wireless network node 12-(N-1) in the manner described above with respect to FIG. 3. Further, the information obtained in step 412 may be obtained by the central node 18 in the same manner as described above with respect to the wireless network nodes 12-2 and 12-3. Once the central node 18 has selected the cooperative strategy for the wireless network node 12-(N-1), the central node 18 provides an indication of the selected cooperative strategy to the wireless network node 12-(N-1) (step 416). At this point, cooperative strategies have been selected for and communicated to all of the relay nodes in the multi-hop route 16. The relay nodes use their cooperative strategies when relaying messages over the multi-hop route 16 (steps 418 through 422).

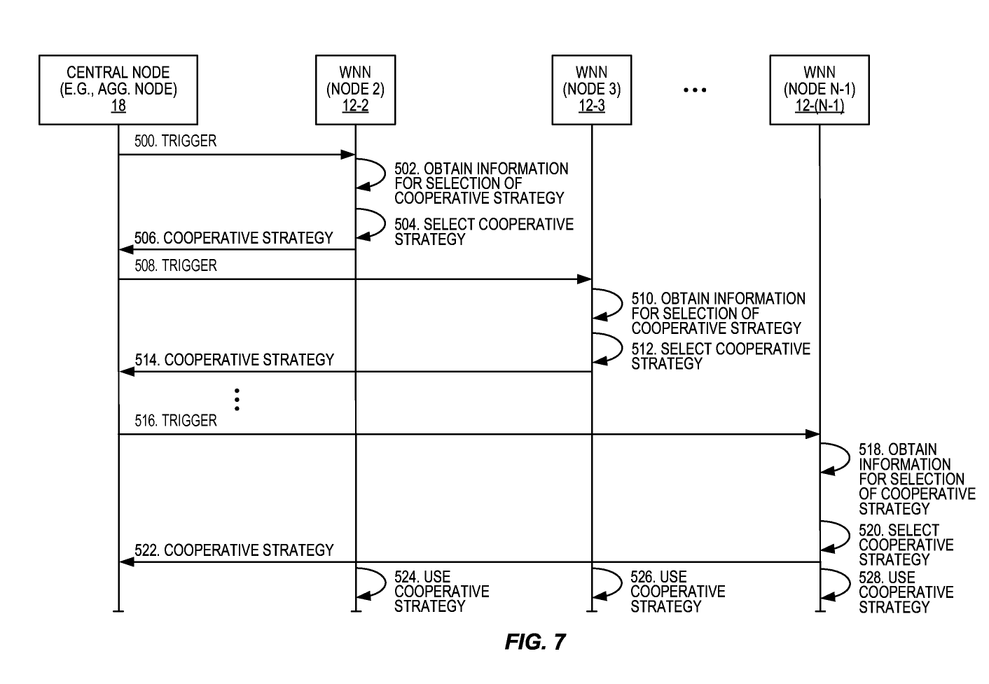

FIG. 7 illustrates a process similar to that of FIGS. 5 and 6 but where the wireless network 10 operates to select cooperative strategies for the relay nodes in the multi-hop route 16 according to a round-robin ordering scheme using a hybrid process (i.e., a hybrid of a centralized and distributed process) according to one embodiment of the present disclosure. This embodiment is similar to that of FIG. 5 but where the central node 18 chooses the next relay node for cooperative strategy selection according to the round-robin scheme rather than the choosing being performed in a distributed manner as is done in the embodiment of FIG. 5.

More specifically, as illustrated, the central node 18 first triggers cooperative strategy selection by the wireless network node 12-2, which is the first relay node in the multi-hop route 16 (step 500). In response, the wireless network node 12-2 obtains information for selection of a cooperative strategy for the wireless network node 12-2 (step 502) and selects a cooperative strategy for the wireless network node 12-2 based on the information (step 504) in the same manner as described above with respect to steps 302 and 304 of FIG. 5. However, in this embodiment, after selecting the cooperative strategy, the wireless network node 12-2 sends an indication of the selected cooperative strategy for the wireless network node 12-2 to the central node 18 (step 506). The indication may be sent directly from the wireless network node 12-2 to the central node 18 (e.g., if the central node 18 is within the range of the wireless network node 12-2 or otherwise connected to the wireless network node 12-2) or may be sent indirectly (e.g., relayed via one or more other wireless network nodes 12).

Once the wireless network node 12-2 has selected its cooperative strategy and sent the indication of the selected cooperative strategy to the central node 18, the central node 18 triggers cooperative strategy selection by the wireless network node 12-3, which is the second relay node in the multi-hop route 16 (step 508). In response, the wireless network node 12-3 obtains information for selection of a cooperative strategy for the wireless network node 12-3 (step 510) and selects a cooperative strategy for the wireless network node 12-3 based on the information (step 512) in the same manner as described above with respect to steps 308 and 310 of FIG. 5. However, in this embodiment, after selecting the cooperative strategy, the wireless network node 12-3 sends an indication of the selected cooperative strategy for the wireless network node 12-3 to the central node 18 (step 514). Again, the indication may be sent directly from the wireless network node 12-3 to the central node 18 (e.g., if the central node 18 is within the range of the wireless network node 12-3 or otherwise connected to the wireless network node 12-3) or may be sent indirectly (e.g., relayed via one or more other wireless network nodes 12).

The process continues in this manner until the central node 18 triggers cooperative strategy selection by the wireless network node 12-(N-1), which is the last relay node in the multi-hop route 16 (step 516). In response, the wireless network node 12-(N-1) obtains information for selection of a cooperative strategy for the wireless network node 12-(N-1) (step 518) and selects a cooperative strategy for the wireless network node 12-(N-1) based on the information (step 520) in the same manner as described above with respect to steps 316 and 318 of FIG. 5. However, in this embodiment, after selecting the cooperative strategy, the wireless network node 12-(N-1) sends an indication of the selected cooperative strategy for the wireless network node 12-(N-1) to the central node 18 (step 522). Again, the indication may be sent directly from the wireless network node 12-(N-1) to the central node 18 (e.g., if the central node 18 is within the range of the wireless network node 12-(N-1) or otherwise connected to the wireless network node 12-(N-1)) or may be sent indirectly (e.g., relayed via one or more other wireless network nodes 12). At this point, all of the relay nodes have selected their cooperative strategies. The relay nodes use their cooperative strategies when relaying messages over the multi-hop route 16 (steps 524 through 528).

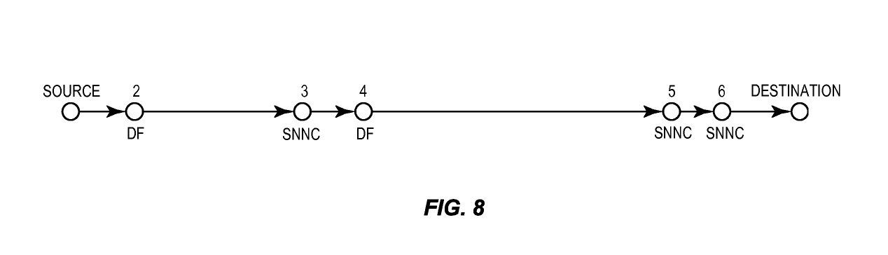

FIG. 8 illustrates one example of round-robin ordering. In FIG. 8, round-robin ordering and the SINR based criterion are used to choose a cooperative strategy for each relay node in the illustrated example of the multi-hop route 16. In this illustration, the distance between the wireless network nodes 12 corresponds to a radio distance (inversely related to SINR) between the wireless network nodes 12 (i.e., a larger distance in the illustration corresponds to a smaller SINR or, in other words, a small SINR corresponds to a large radio distance between the corresponding wireless network nodes 12). The threshold value Th is set to 0.6. Node 2 is closer to the source wireless network node than to node 3 and therefore DF is selected for node 2; node 3 is closer to node 4 than to node 2 and therefore SNNC is selected for node 3, and so on. Note that, although node 6 is closer to node 5 than to the destination wireless network node, SNNC is selected for node 6 because node 6 is closer to the destination wireless network node than to node 4. The arrows indicate the multi-hop route 16, but both cooperative strategies (i.e., DF and SNNC) deploy overhearing in which a node will use signals sent from multiple preceding, or upstream, nodes for decoding.

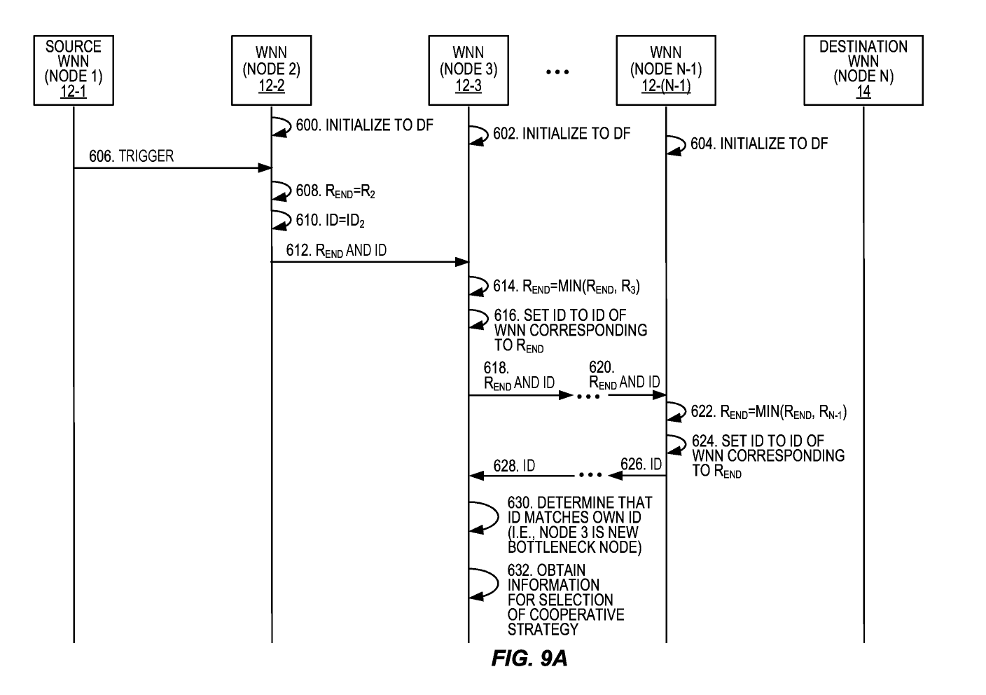

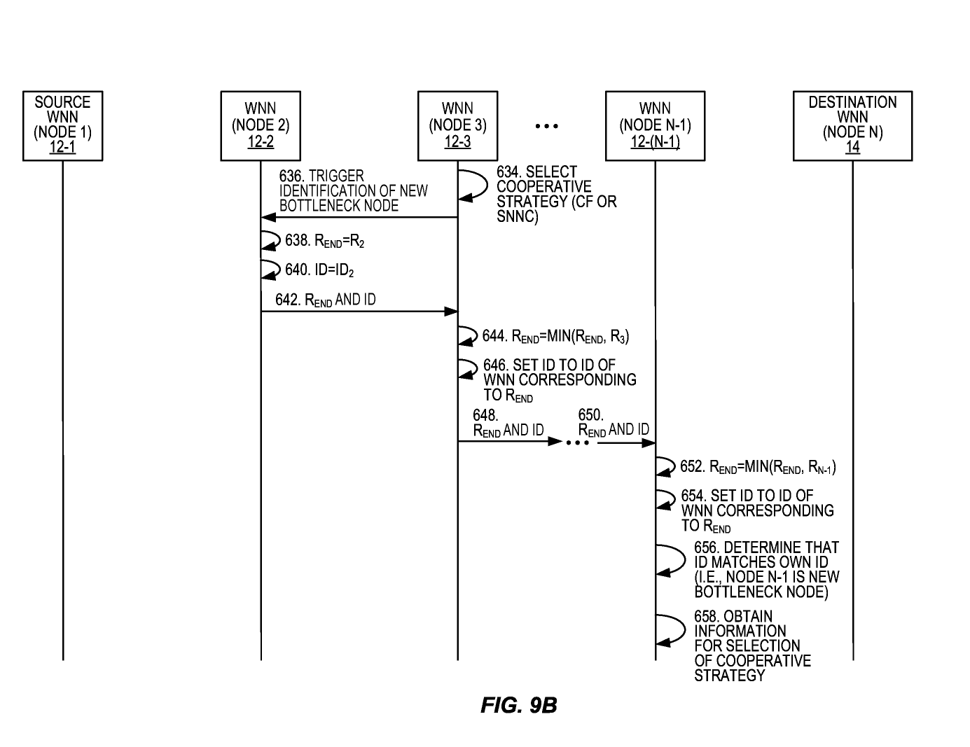

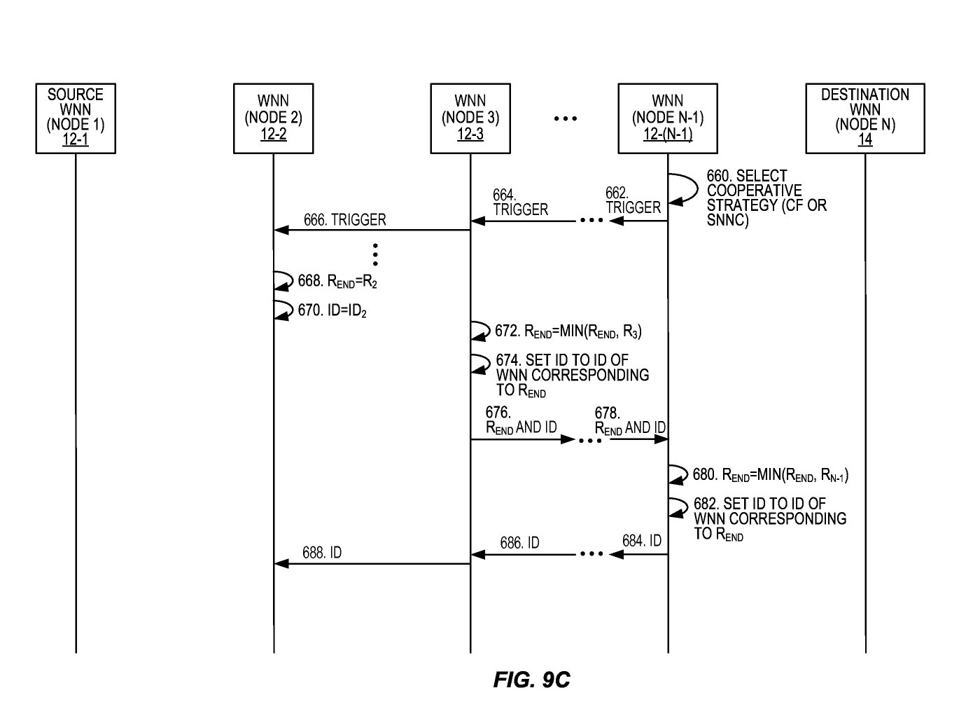

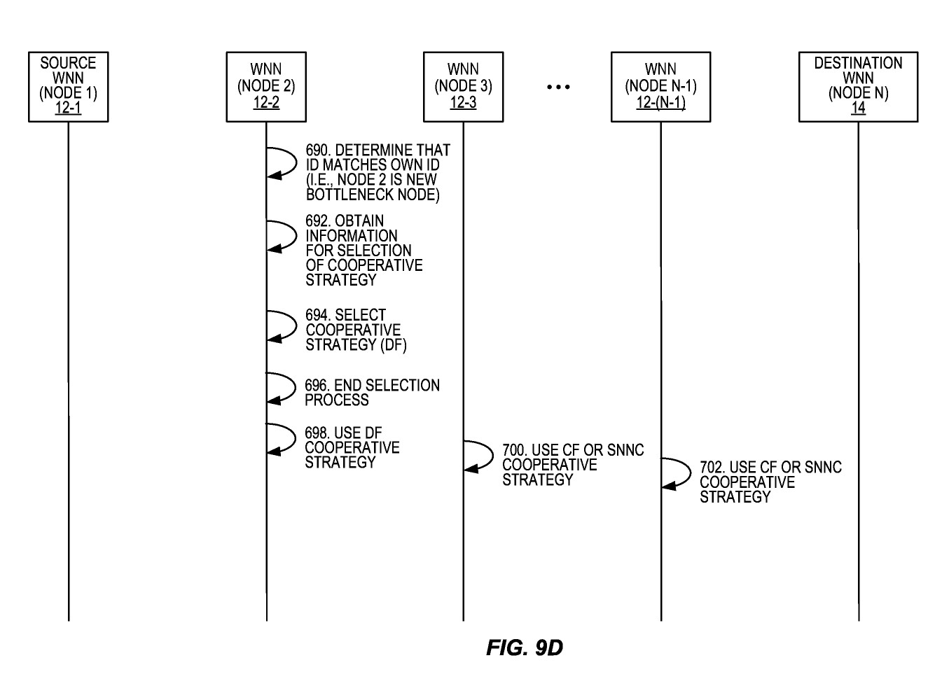

While FIGS. 5 through 8 illustrate embodiments that use round-robin ordering, FIGS. 9A through 9D, 10A, 10B, 11A, and 11B illustrate embodiments that use bottleneck ordering according to some other embodiments of the present disclosure. In this regard, FIGS. 9A through 9D illustrate the operation of the wireless network 10 to select cooperative strategies for the relay nodes in the multi-hop route 16 according to a bottleneck ordering scheme using a distributed process according to one embodiment of the present disclosure. In this embodiment, all of the relay nodes (i.e., all of the wireless network nodes 12-2 through 12-(N-1)) in the multi-hop route 16 are initialized to the DF cooperative strategy (steps 600 through 604). Note that the DF and SNNC/CF cooperative strategies are utilized in this example. However, other cooperative strategies may be used.

After initialization, the source wireless network node 12-1 triggers a bottleneck identification process (step 606). Note that the following bottleneck identification process is only one example. Other bottleneck identification processes may be used (e.g., identify bottleneck node based on central knowledge of SINR values or achievable data rates at all receiving nodes in the multi-hop route 16). In response, the wireless network node 12-2 sets an end-to-end data rate parameter (R_{END}) to the achievable rate (R₂) for the wireless network node 12-2 (step 608), i.e., the rate at which the wireless network node 12-2 can reliably decode the incoming messages. In addition, the wireless network node 12-2 sets an identifier parameter (ID) to an identifier of the wireless network node 12-2 (ID₂) (step 610). The wireless network node 12-2 then sends the end-to-end data rate (R_{END}) and identifier (ID) of the corresponding node, which at this point is the wireless network node 12-2, to the wireless network node 12-3 (step 612). The wireless network node 12-3 then updates the end-to-end data rate (R_{END}) according to the equation:

R_{END}=min(R_{END},R₃),

where R₃ is a data rate for the wireless network node 12-3 (step 614). In addition, the wireless network node 12-3 updates the ID parameter to store the identifier of the wireless network node 12-2 or 12-3 that corresponds to the updated, or new, end-to-end data rate (R_{END}) determined in step 614 (step 616). The wireless network node 12-3 then sends the end-to-end data rate (R_{END}) and the identifier (ID) obtained in steps 614 and 616 to the next wireless network node 12-4 (not shown) (step 618).

The process continues in this manner until the wireless network node 12-(N-1) (i.e., the last relay node) receives the end-to-end data rate (R_{END}) and the identifier (ID) of the corresponding wireless network node 12 from its upstream wireless network node 12-(N−2) (step 620). The wireless network node 12-(N-1) then updates the end-to-end data rate (R_{END}) according to the equation:

R_{END}=min(R_{END},R_{N-1}),

where R_{N-1} is a data rate for the wireless network node 12-(N-1) (step 622). In addition, the wireless network node 12-(N-1) updates the ID parameter to store the identifier of the wireless network node 12-2, 12-3, . . . , or 12-(N-1) that corresponds to the updated, or new, end-to-end data rate (R_{END}) determined in step 622 (step 624). At this point, the wireless network node 12-2, 12-3, . . . , or 12-(N-1) identified by the identifier (ID) is the bottleneck node for the multi-hop route 16 and, as such, that wireless network node 12 is chosen, or selected, for cooperative strategy selection. In this example, the wireless network node 12-3 is identified as the bottleneck node.

In this embodiment, in order to trigger cooperative strategy selection for the wireless network node 12-3, the identifier (ID) is propagated back through the multi-hop route 16 until the identifier (ID) is received by the wireless network node 12-3 (steps 626 and 628). Upon receiving the identifier (ID), the wireless network node 12-3 determines that the identifier (ID) matches its own identifier or, in other words, determines that it is the new bottleneck node (step 630). In response, the wireless network node 12-3 obtains information for selection of a cooperative strategy for the wireless network node 12-3 (step 632) and selects a cooperative strategy for the wireless network node 12-3 based on the information (step 634), in the manner described above.

In this embodiment, the cooperative strategy selection process ends when the cooperative strategy selected by the bottleneck node is the DF cooperative strategy or cooperative strategies have been selected for all relay nodes in the multi-hop route 16. In this example, the wireless network node 12-3 selects the CF or SNNC cooperative strategy. As such, the selection process continues. In this embodiment, the wireless network node 12-3 triggers the bottleneck identification process (step 636). At that point, the bottleneck identification process described above is repeated taking into consideration the cooperative strategy for the wireless network node 12-3 selected in step 634 (which will affect the data rate of the wireless network node 12-3) (steps 638 through 654).

In this second iteration of the bottleneck identification process, the wireless network node 12-(N-1) is identified as the new bottleneck node. As such, after setting the ID in step 654, the wireless network node 12-(N-1) determines that the identifier (ID) matches its own identifier or, in other words, determines that it is the new bottleneck node (step 656). In response, the wireless network node 12-(N-1) obtains information for selection of a cooperative strategy for the wireless network node 12-(N-1) (step 658) and selects a cooperative strategy for the wireless network node 12-(N-1) based on the information (step 660), in the manner described above. In this example, the wireless network node 12-(N-1) selects the CF or SNNC cooperative strategy and, as such, the process continues. As such, the wireless network node 12-(N−1) triggers the bottleneck identification process (steps 662 through 666). In this example, the process continues in this manner to provide selection of cooperative strategies for one or more additional relay nodes (not shown) until the bottleneck identification process is triggered a final time. In this example, the final bottleneck identification process is “final” in the sense that, as discussed below, the resulting new bottleneck node identified by the process selects the DF cooperative strategy, which in turn ends the cooperative strategy selection process.

More specifically, the bottleneck identification process is performed as described above taking into consideration the selected cooperative strategies (steps 668 through 688). In this iteration, the wireless network node 12-2 is identified as the new bottleneck node. As such, upon receiving the identifier (ID) in step 688, the wireless network node 12-2 determines that the identifier (ID) matches its own identifier or, in other words, determines that it is the new bottleneck node (step 690). In response, the wireless network node 12-2 obtains information for selection of a cooperative strategy for the wireless network node 12-2 (step 692) and selects a cooperative strategy for the wireless network node 12-2 based on the information (step 694), in the manner described above. In this example, the wireless network node 12-2 selects the DF cooperative strategy and, as such, the cooperative strategy selection process is complete (step 696).

The wireless network nodes 12-2 through 12-(N-1) use their cooperative strategies when relaying messages over the multi-hop route 16 (steps 698 through 702). Notably, the wireless network nodes 12 identified as the bottleneck nodes in the different iterations of the bottleneck identification process will use the cooperative strategies selected by those wireless network nodes 12 in response to being identified as the bottleneck nodes. Conversely, in some instances, not all of the relay nodes (i.e., not all of the wireless network nodes 12-2 through 12-(N-1)) may be identified as bottleneck nodes, in which case cooperative strategy selection will not be triggered at these relay nodes. In the example above, this will occur when the cooperative strategy selection process ends as a result of a bottleneck node selecting the DF cooperative strategy. Any of the relay nodes that had not yet been identified as bottleneck nodes will not have explicitly selected a cooperative strategy. However, these relay nodes will have been initialized to the DF cooperative strategy and therefore select the DF cooperative strategy.

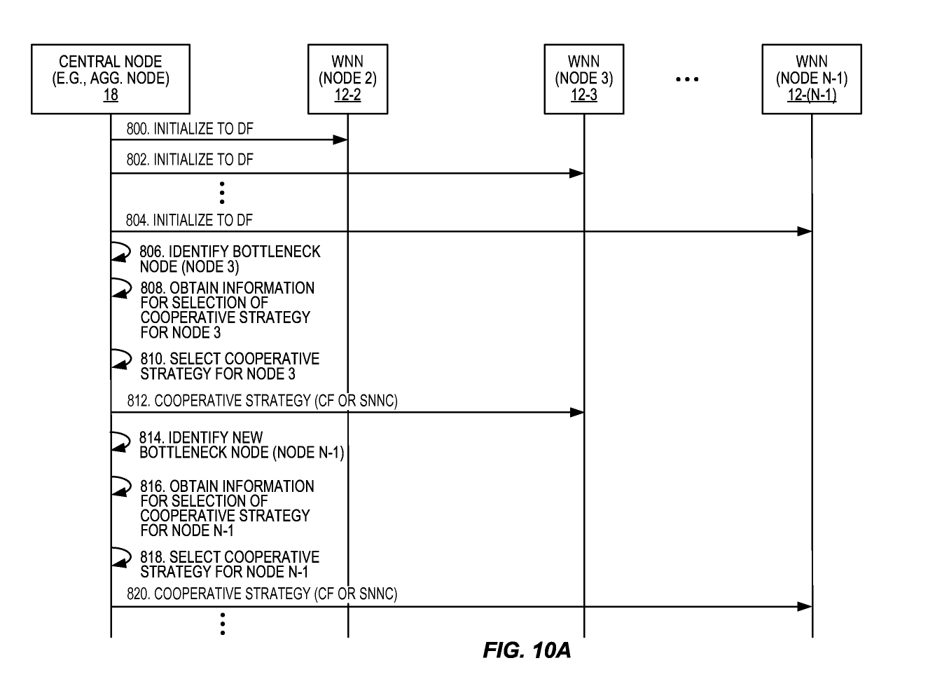

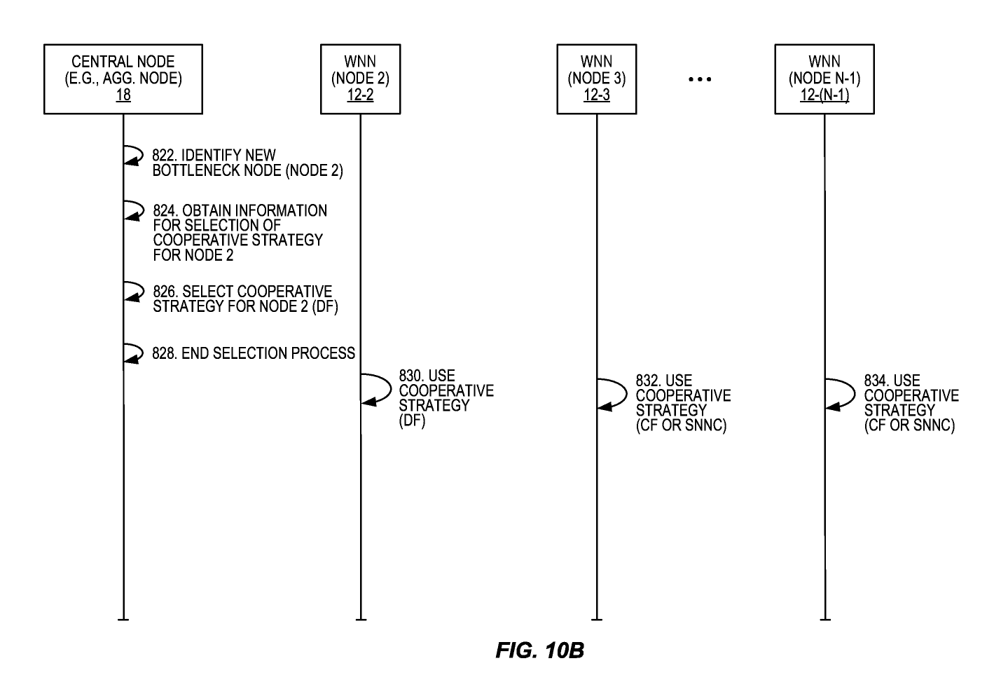

FIGS. 10A and 10B illustrate the operation of the wireless network 10 to select cooperative strategies for the relay nodes in the multi-hop route 16 according to a bottleneck ordering scheme using a centralized process according to one embodiment of the present disclosure. In general, this embodiment is similar to that of FIGS. 9A through 9D but where the process is centralized at the central node 18. In this embodiment, all of the relay nodes (i.e., all of the wireless network nodes 12-2 through 12-(N-1)) in the multi-hop route 16 are initialized to the DF cooperative strategy (steps 800 through 804). In this embodiment, the wireless network nodes 12-2 through 12-(N-1) are initialized by the central node 18, where corresponding initialization messages are sent directly from the central node 18 to the wireless network nodes 12-2 through 12-(N-1) (if possible) or indirectly from the central node 18 to the wireless network nodes 12-2 through 12-(N-1) (e.g., via relaying through one or more other wireless network nodes 12). Note that the DF and SNNC/CF cooperative strategies are utilized in this example. However, other cooperative strategies may be used.

After initialization, the central node 18 identifies a bottleneck node for the multi-hop route 16 (step 806). In one embodiment, the central node 18 identifies the bottleneck node by triggering the bottleneck node identification process described above but where the identifier (ID) of the bottleneck node is returned to the central node 18. In this example, the bottleneck node is the wireless network node 12-3 (i.e., node 3). The central node 18 then obtains information for selection of a cooperative strategy for the wireless network node 12-3 (step 808) and selects a cooperative strategy for the wireless network node 12-3 based on the information (step 810), in the manner described above. The central node 18 then sends an indication of the selected cooperative strategy to the wireless network node 12-3, either directly or indirectly (step 812).

In this embodiment, the cooperative strategy selection process ends when the cooperative strategy selected for the bottleneck node is the DF or cooperative strategies have been selected for all relay nodes in the multi-hop route 16. In this example, the cooperative strategy selected for the wireless network node 12-3 is the CF or SNNC cooperative strategy. As such, the selection process continues. In this embodiment, the central node 18 identifies a new bottleneck node for the multi-hop route 16 taking into consideration the cooperative strategy selected for the wireless network node 12-3 (i.e., the previous bottleneck node) (step 814). In this iteration, the wireless network node 12-(N-1) is identified as the new bottleneck node. As such, the central node 18 obtains information for selection of a cooperative strategy for the wireless network node 12-(N-1) (step 816) and selects a cooperative strategy for the wireless network node 12-(N-1) based on the information (step 818), in the manner described above. The central node 18 then sends an indication of the selected cooperative strategy to the wireless network node 12-(N-1), either directly or indirectly (step 820). In this example, the CF or SNNC cooperative strategy is selected for the wireless network node 12-(N-1) and, as such, the process continues.

The process continues in this manner until the central node 18 identifies, in this example, the wireless network node 12-2 as the new bottleneck node (step 822). As such, the central node 18 obtains information for selection of a cooperative strategy for the wireless network node 12-2 (step 824) and selects a cooperative strategy for the wireless network node 12-2 based on the information (step 826), in the manner described above. The central node 18 then sends an indication of the selected cooperative strategy to the wireless network node 12-2, either directly or indirectly. In this example, the DF cooperative strategy is selected for wireless network node 12-2. As such, the central node 18 may not send an indication of the selected cooperative strategy to the wireless network node 18 since the wireless network node 18 has already been initialized to the DF cooperative strategy. In response to selecting the DF cooperative strategy for the wireless network node 12-2 (i.e., the new bottleneck node), the central node 18 ends the cooperative strategy selection process (step 828). In other words, the central node 18 can assume that all other relay nodes are to operate according to the DF cooperative strategy.

The wireless network nodes 12-2 through 12-(N-1) use their cooperative strategies when relaying messages over the multi-hop route 16 (steps 830 through 834). Notably, the wireless network nodes 12 identified as the bottleneck nodes in the different iterations of the bottleneck identification process will use the cooperative strategies selected for those wireless network nodes 12 in response to being identified as the bottleneck nodes. Conversely, in some instances, not all of the relay nodes may be identified as bottleneck nodes, in which case cooperative strategy selection will not be triggered for these relay nodes. In the example above, this will occur when the cooperative strategy selection process ends as a result of a bottleneck node selecting the DF cooperative strategy. Cooperative strategies for any of the relay nodes that had not yet been identified as bottleneck nodes will not have been explicitly selected. However, these relay nodes will have been initialized to the DF cooperative strategy and therefore select the DF cooperative strategy.

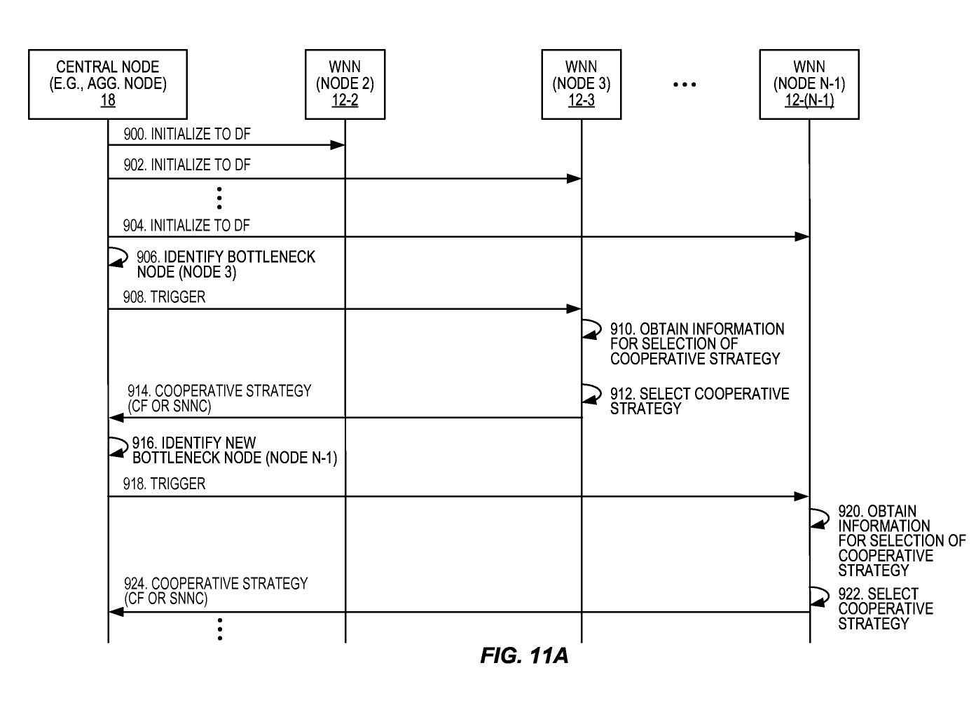

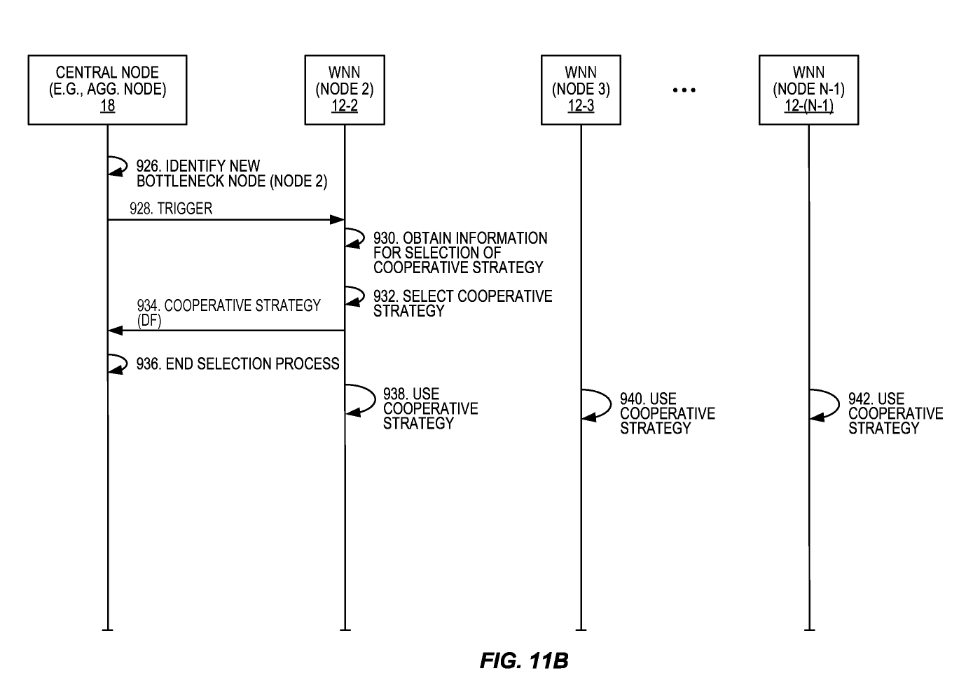

FIGS. 11A and 11B illustrate the operation of the wireless network 10 to select cooperative strategies for the relay nodes in the multi-hop route 16 according to a bottleneck ordering scheme using a hybrid process according to one embodiment of the present disclosure. In general, this embodiment is similar to that of FIGS. 10A and 10B but where selection of the cooperative strategies is performed at the bottleneck nodes. In this embodiment, all of the relay nodes (i.e., all of the wireless network nodes 12-2 through 12-(N-1)) in the multi-hop route 16 are initialized to the DF cooperative strategy (steps 900 through 904). In this embodiment, the wireless network nodes 12-2 through 12-(N-1) are initialized by the central node 18, where corresponding initialization messages are sent directly from the central node 18 to the wireless network nodes 12-2 through 12-(N-1) (if possible) or indirectly from the central node 18 to the wireless network nodes 12-2 through 12-(N-1) (e.g., via relaying through one or more other wireless network nodes 12). Note that the DF and SNNC/CF cooperative strategies are utilized in this example. However, other cooperative strategies may be used.

After initialization, the central node 18 identifies a bottleneck node for the multi-hop route 16 (step 906). In one embodiment, the central node 18 identifies the bottleneck node by triggering the bottleneck node identification process described above but where the identifier (ID) of the bottleneck node is returned to the central node 18. In this example, the bottleneck node is the wireless network node 12-3 (i.e., node 3). The central node 18 then triggers cooperative strategy selection at the wireless network node 12-3 (step 908). In response, the wireless network node 12-3 obtains information for selection of a cooperative strategy for the wireless network node 12-3 (step 910) and selects a cooperative strategy for the wireless network node 12-3 based on the information (step 912), in the manner described above. The wireless network node 12-3 then sends an indication of the cooperative strategy selected for the wireless network node 12-3 to the central node 18 (step 914).

In this embodiment, the cooperative strategy selection process ends when the cooperative strategy selected for the bottleneck node is the DF or cooperative strategies have been selected for all relay nodes in the multi-hop route 16. In this example, the wireless network node 12-3 selects the CF or SNNC cooperative strategy. As such, the selection process continues. In this embodiment, the central node 18 identifies a new bottleneck node for the multi-hop route 16 taking into consideration the cooperative strategy selected for the wireless network node 12-3 (i.e., the previous bottleneck node) (step 916). In this iteration, the wireless network node 12-(N-1) is identified as the new bottleneck node. As such, the central node 18 then triggers cooperative strategy selection at the wireless network node 12-(N-1) (step 918). In response, the wireless network node 12-(N-1) obtains information for selection of a cooperative strategy for the wireless network node 12-(N-1) (step 920) and selects a cooperative strategy for the wireless network node 12-(N-1) based on the information (step 922), in the manner described above. The wireless network node 12-(N-1) then sends an indication of the cooperative strategy selected for the wireless network node 12-(N-1) to the central node 18 (step 924).

The process continues in this manner until the central node 18 identifies, in this example, the wireless network node 12-2 as the new bottleneck node (step 926). As such, the central node 18 then triggers cooperative strategy selection at the wireless network node 12-2 (step 928). In response, the wireless network node 12-2 obtains information for selection of a cooperative strategy for the wireless network node 12-2 (step 930) and selects a cooperative strategy for the wireless network node 12-2 based on the information (step 932), in the manner described above. The wireless network node 12-2 then sends an indication of the cooperative strategy selected for the wireless network node 12-2 to the central node 18 (step 934). In response to the selection of the DF cooperative strategy for the wireless network node 12-2 (i.e., the new bottleneck node), the central node 18 ends the cooperative strategy selection process (step 936). In other words, the central node 18 can assume that all other relay nodes are to operate according to the DF cooperative strategy.

The wireless network nodes 12-2 through 12-(N-1) use their cooperative strategies when relaying messages over the multi-hop route 16 (steps 938 through 942). Notably, the wireless network nodes 12 identified as the bottleneck nodes in the different iterations of the bottleneck identification process will use the cooperative strategies selected for those wireless network nodes 12 in response to being identified as the bottleneck nodes. Conversely, in some instances, not all of the relay nodes may be identified as bottleneck nodes, in which case cooperative strategy selection will not be triggered for these relay nodes. In the example above, this will occur when the cooperative strategy selection process ends as a result of a bottleneck node selecting the DF cooperative strategy. Cooperative strategies for any of the relay nodes that had not yet been identified as bottleneck nodes will not have been explicitly selected. However, these relay nodes will have been initialized to the DF cooperative strategy and therefore select the DF cooperative strategy.

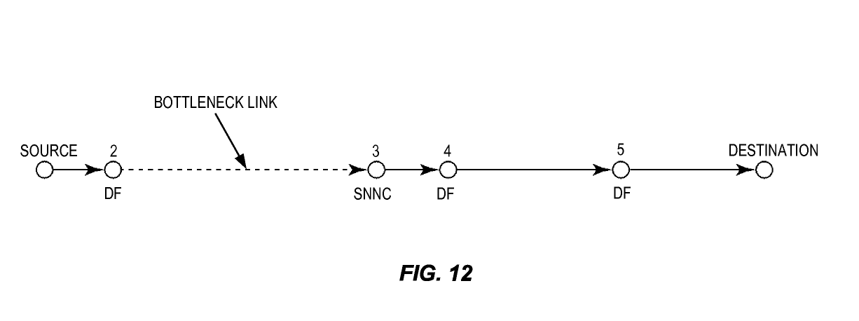

FIG. 12 illustrates one example of the multi-hop route 16 and one iteration of cooperative strategy selection using the bottleneck ordering scheme and the data rate based decision criterion discussed above according to one embodiment of the present disclosure. First, all of the relay nodes (i.e., nodes 2 through node 5) are initiated to the DF cooperative strategy. After the achievable data rate using the DF cooperative strategy is calculated at each relay node, it is concluded that the rate at node 3 is the bottleneck (due to the least favorable position of node 3). Therefore, node 3 is identified as the bottleneck node. Next, it is assumed that node 3 performs SNNC, which results in a new achievable rate at node 4 (and there is no rate constraint at node 3 because that node does not decode the data) and therefore a new end-to-end data rate. After comparing this new end-to-end rate to the one achieved when node 3 performs DF, it is decided that (in this case) SNNC is selected for node 3. As discussed above, a new bottleneck node is then identified and the process is repeated.

Note that cooperative strategy selection as described herein can be done on different time scales. Specifically, to adapt to network topology, the cooperative strategy selection will depend only on node positions and hence does not need to be changed, or updated, often. The criterion used for cooperative strategy selection in this case may be, for example, based on average SINR values. This approach will have small control overhead. To further increase the network performance, cooperative strategy selection can adapt also to channel conditions. In this case, cooperative strategy selection will be performed on the smaller time scale. Furthermore, updating or adaption of the cooperative strategy may be done only partially, e.g., only on the nodes that experience large variations in SINR values. For example, if a SINR of a node improves significantly, a SNNC relay can use this opportunity to decode data and vice versa.

The embodiments described herein can be used to select a cooperative strategy for each relay node in a multi-hop route through a wireless network. For each particular route in the network, a decision criterion enables selection of a cooperative strategy for each relay node in the route such that the overall performance (e.g., end-to-end rate) on the route is improved. Further, the embodiments disclosed herein can be exploited in any network scenario in which data is sent through relays (full or half-duplex, with or without multiple antennas). Therefore, it applies to wireless networks in general and particular applications such as multi-hop backhaul, network-assisted device-to-device communications, cellular networks with relays, etc.

In some of the embodiments described herein the choice of cooperative strategy for each relay node is between DF and CF or SNNC (i.e., it is assumed that the relay nodes are decoding and relaying messages via DF or compressing via CF or SNNC). However, the embodiments described herein are not limited to DF and CF or SNNC and can be used with other cooperative strategies such as, for example, SF, partial DF, etc., and cooperative strategies without decoding such as, for example, amplify-and-forward. One example of compressed versions of signals are demodulated soft coded bits, which can be obtained by exploiting the modulation and the additive-noise structure of the received signal using a soft-output demodulator for the overheard signal (after removal of the contribution from previously decoded blocks). Other examples include hard decoded information bits, or soft decoded information bits, which can be obtained by further exploiting the structure of the underlying channel code.

The embodiments disclosed herein apply to networks with a single source-destination node with one or multiple routes to the destination, as well to the case in which there are multiple source-destination pairs. Further, the embodiments described herein generalize to the network scenarios in which some or all the nodes are equipped with multiple transmit/receive antennas.

While not being limited to any particular advantage, the embodiments disclosed herein may be implemented to provide a number of advantages. In this regard, as discussed above, decoding-based and compression-based cooperative strategies have complementary advantages and drawbacks. No single cooperative strategy is optimal for all relay node positions and channel conditions. The best performing cooperative strategy for a relay node on a route depends on the received signal strength at the relay node and the received signal strength at the node to which the relay node is transmitting. These, in turn, depend on the relative position and current channel conditions at the relay node, and therefore vary from node to node. Embodiments of the present disclosure build on this observation and propose processes by which the best cooperative strategy is chosen for each individual relay node. By optimizing the cooperative strategy for each relay node, these embodiments can adapt to network topology and channel conditions thereby improving the network performance. These embodiments can improve both the throughput and the energy-efficiency of the network.

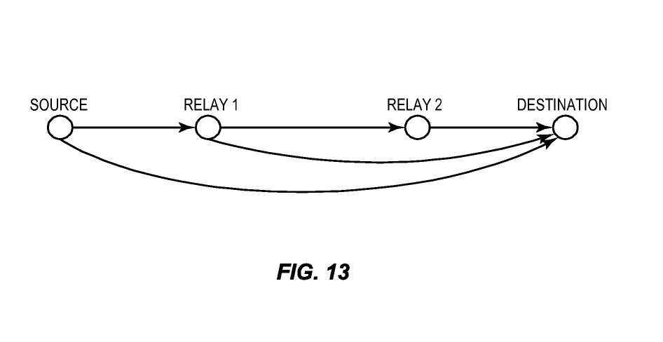

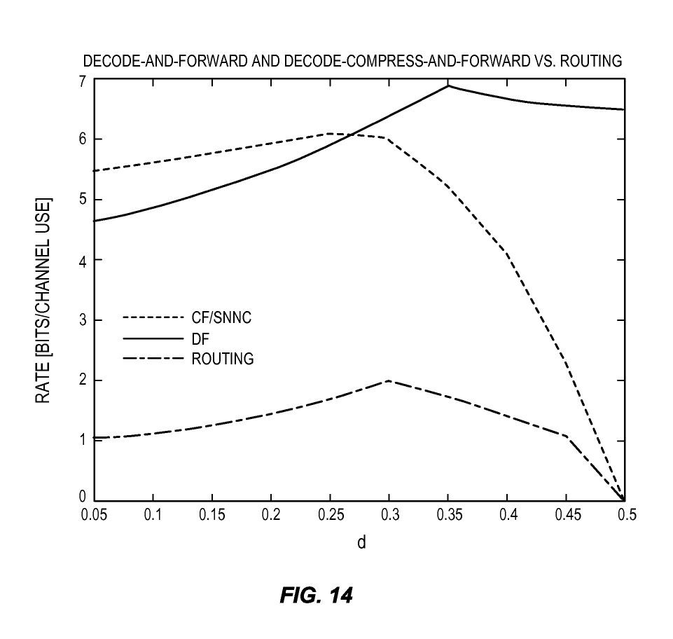

The following example demonstrates the gains of mixed cooperative strategies on a simple multi-hop route illustrated in FIG. 13. A source node wishes to send data to a destination node via a multi-hop route that includes two relay nodes. FIG. 14 illustrates performance for three strategies at the relay nodes, namely: (1) both relay nodes use SF, (2) both relay nodes use DF, and (3) relay node 1 uses DF and relay node 2 uses CF. As can be observed from FIG. 14, for small d (d<0.25) when the two relays are far from one another, the mixed strategy (relay node 1 uses DF and relay node 2 uses CF) outperforms the other two strategies.

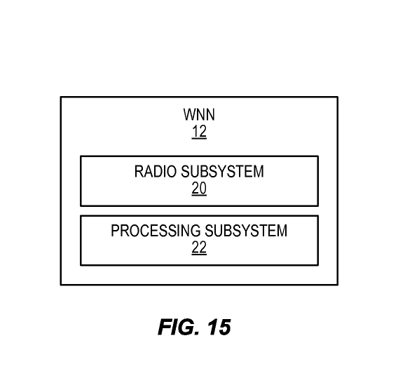

FIG. 15 is a block diagram of one of the wireless network nodes 12 according to one embodiment of the present disclosure. This discussion is equally applicable to the other wireless network nodes 12. Further, the aggregation node 14 may have the same or similar architecture. As illustrated, the wireless network node 12 includes a radio subsystem 20 and a processing subsystem 22. The radio subsystem 20 generally includes analog and, in some embodiments, digital components for wirelessly sending and receiving data to and from other wireless network nodes 12 and, in some embodiments, wireless devices served by the wireless network node 12 (e.g., in the case where the wireless network node 12 is an access node). From a wireless communications protocol view, the radio subsystem 20 implements at least part of Layer 1 (i.e., the Physical or “PHY” Layer).

The processing subsystem 22 generally implements any remaining portion of Layer 1 not implemented in the radio subsystem 20 as well as functions for higher layers in the wireless communications protocol (e.g., Layer 2 (data link layer), Layer 3 (network layer), etc.). In particular embodiments, the processing subsystem 22 may comprise, for example, one or several general-purpose or special-purpose microprocessors or other microcontrollers programmed with suitable software and/or firmware to carry out some or all of the functionality of the wireless network node 12 described herein. In addition or alternatively, the processing subsystem 22 may comprise various digital hardware blocks (e.g., one or more Application Specific Integrated Circuits (ASICs), one or more off-the-shelf digital and analog hardware components, or a combination thereof) configured to carry out some or all of the functionality of the wireless network node 12 described herein. Additionally, in particular embodiments, the above described functionality of the wireless network node 12 may be implemented, in whole or in part, by the processing subsystem 22 executing software or other instructions stored on a non-transitory computer-readable medium, such as Random Access Memory (RAM), Read Only Memory (ROM), a magnetic storage device, an optical storage device, or any other suitable type of data storage components.

The following acronyms are used throughout this disclosure.
ASIC Application Specific Integrated Circuit
CF Compress-and-Forward
DF Decode-and-Forward
ID Identifier
NNC Noisy Network Coding
RAM Random Access Memory
ROM Read Only Memory
SF Store-and-Forward
SINR Signal-to-Interference plus Noise Ratio
SNNC Short Message Noisy Network Coding
UE User Equipment

Those skilled in the art will recognize improvements and modifications to the preferred embodiments of the present disclosure. All such improvements and modifications are considered within the scope of the concepts disclosed herein and the claims that follow.

What is claimed is:

1. A method comprising:
selecting a cooperative strategy for a relay node in a wireless network from a set of two or more cooperative strategies, the cooperative strategy defining a manner in which the relay node relays messages along a multi-hop route through the wireless network; and
effecting use of the cooperative strategy by the relay node.

2. The method of claim 1 wherein selecting the cooperative strategy comprises selecting the cooperative strategy from the set of two or more cooperative strategies based on one or more channel quality based criteria.

3. The method of claim 1 wherein selecting the cooperative strategy comprises selecting the cooperative strategy from the set of two or more cooperative strategies based on a data rate based criterion.

4. The method of claim 3 wherein selecting the cooperative strategy from the set of two or more cooperative strategies based on the data rate based criterion comprises:
selecting one of the set of two or more cooperative strategies for the relay node that provides a highest end-to-end data rate for the multi-hop route.

5. The method of claim 3 wherein the two or more cooperative strategies comprise a first cooperative strategy that requires decoding of received messages and a second cooperative strategy that does not require decoding of received messages, and selecting the cooperative strategy from the set of two or more cooperative strategies based on the data rate based criterion comprises:
determining a first end-to-end data rate for the multi-hop route assuming the first cooperative strategy for the relay node;
determining a second end-to-end data rate for the multi-hop route assuming the second cooperative strategy for the relay node;
selecting the first cooperative strategy as the cooperative strategy for the relay node if the first end-to-end data rate is greater than the second end-to-end data rate; and
selecting the second cooperative strategy as the cooperative strategy for the relay node if the first end-to-end data rate is less than the second end-to-end data rate.

6. The method of claim 5 wherein the first cooperative strategy is a decode-and-forward cooperative strategy, and the second cooperative strategy is one of a group consisting of: a compress-and-forward cooperative strategy and a short message noisy network coding cooperative strategy.

7. The method of claim 1 wherein selecting the cooperative strategy comprises selecting the cooperative strategy from the set of two or more cooperative strategies based on a Signal-to-Interference plus Noise Ratio, SINR, based criterion.

8. The method of claim 7 wherein the two or more cooperative strategies comprise a first cooperative strategy that requires decoding of received messages and a second cooperative strategy that does not require decoding of received messages, and selecting the cooperative strategy from the set of two or more cooperative strategies based on the SINR based criterion comprises:
determining a first SINR value for an incoming wireless link to the relay node from a nearest upstream wireless network node in the multi-hop route that is utilizing the first cooperative strategy;
determining a second SINR value for an outgoing wireless link from the relay node to an immediate downstream wireless network node in the multi-hop route;
selecting the first cooperative strategy as the cooperative strategy for the relay node if a ratio of the first SINR value and the second SINR value is greater than a predefined threshold; and
selecting the second cooperative strategy as the cooperative strategy for the relay node if the ratio of the first SINR value and the second SINR value is less than the predefined threshold.

9. The method of claim 1 wherein the two or more cooperative strategies comprise a first cooperative strategy that requires decoding of received messages and a second cooperative strategy that does not require decoding of received messages.

10. The method of claim 9 wherein the first cooperative strategy is a decode-and-forward cooperative strategy and the second cooperative strategy is one of a group consisting of: a compress-and-forward cooperative strategy and a short message noisy network coding cooperative strategy.

11. The method of claim 9 further comprising:
determining a signal quality for an incoming wireless link to the relay node;
wherein selecting the cooperative strategy for the relay node comprises:
selecting the first cooperative strategy if the signal quality is better than a predefined threshold signal quality; and
selecting the second cooperative strategy if the signal quality is worse than the predefined threshold signal quality.

12. The method of claim 1 further comprising:
obtaining information from one or more wireless network nodes in the wireless network;
wherein selecting the cooperative strategy for the relay node comprises selecting the cooperative strategy based on the information.

13. The method of claim 12 wherein the information comprises information that is indicative of a cooperative strategy selected by one or more upstream wireless network nodes of the relay node in the multi-hop route.

14. The method of claim 12 wherein the information comprises at least one of a group consisting of: one or more Signal-to-Interference plus Noise Ratio, SINR, values and two or more end-to-end data rates for the multi-hop route each assuming selection of a different one of the two or more cooperative strategies for the relay node.

15. The method of claim 1 wherein the wireless network is a wireless mesh network.

16. The method of claim 15 wherein the wireless mesh network is a backhaul network between a plurality of access nodes of a cellular communications network, and the relay node is one of the plurality of access nodes.

17. The method of claim 1 wherein:
selecting the cooperative strategy for the relay node comprises selecting the cooperative strategy for the relay node at the relay node; and
effecting use of the cooperative strategy by the relay node comprises using the cooperative strategy at the relay node when relaying messages over the multi-hop route.

18. The method of claim 17 further comprising sending information that is indicative of the cooperative strategy selected for the relay node to one or more other wireless network nodes in the wireless network.

19. The method of claim 1 wherein:
selecting the cooperative strategy for the relay node comprises selecting the cooperative strategy for the relay node at a central node associated with the wireless network; and
effecting use of the cooperative strategy by the relay node comprises causing, by the central node, the relay node to use the cooperative strategy when relaying messages over the multi-hop route.

20. A device, comprising:
a radio subsystem; and
a processing subsystem associated with the radio subsystem, the processing subsystem configured to:
select a cooperative strategy for a relay node in a wireless network from a set of two or more cooperative strategies, the cooperative strategy defining a manner in which the relay node relays messages along a multi-hop route through the wireless network; and
effect use of the cooperative strategy by the relay node.

21. A method, comprising:
choosing, according to an ordering scheme, a relay node from two or more relay nodes in a multi-hop route through a wireless network for cooperative strategy selection; and
selecting a cooperative strategy for the relay node from a set of two or more cooperative strategies, the cooperative strategy defining a manner in which the relay node relays messages along the multi-hop route.

22. The method of claim 21 further comprising:
choosing, according to the ordering scheme, a next relay node from the two or more relay nodes in the multi-hop route for cooperative strategy selection; and
selecting a cooperative strategy for the next relay node from the set of two or more cooperative strategies, the cooperative strategy selected for the next relay node defining a manner in which the next relay node relays messages along the multi-hop route.

23. The method of claim 22 wherein the ordering scheme is a round-robin ordering scheme.

24. The method of claim 22 wherein the ordering scheme is a bottleneck ordering scheme.

25. The method of claim 24 wherein choosing the relay node according to the bottleneck ordering scheme comprises:
initializing each relay node of two or more relay nodes included in the multi-hop route to a first cooperative strategy that requires decoding of received messages; and
identifying one of the two or more relay nodes in the multi-hop route as a bottleneck node in the multi-hop route to thereby choose the bottleneck node as the relay node for cooperative strategy selection.

26. The method of claim 25 wherein choosing the next relay node according to the bottleneck ordering scheme comprises:
identifying a different one of the two or more relay nodes in the multi-hop route as a new bottleneck node after selection of the cooperative strategy for the relay node to thereby choose the new bottleneck node as the next relay node for cooperative strategy selection.

27. The method of claim 22 wherein choosing the relay node, selecting the cooperative strategy for the relay node, choosing the next relay node, and selecting the cooperative strategy for the next relay node are performed by the wireless network in a distributed manner.

28. The method of claim 22 wherein choosing the relay node, selecting the cooperative strategy for the relay node, choosing the next relay node, and selecting the cooperative strategy for the next relay node are performed by a central node associated by the wireless network in a centralized manner.

29. The method of claim 22 wherein choosing the relay node, selecting the cooperative strategy for the relay node, choosing the next relay node, and selecting the cooperative strategy for the next relay node are performed partially by a central node associated by the wireless network in a centralized manner and partially by the wireless network in a distributed manner.

30. The method of claim 21 wherein selecting the cooperative strategy for the relay node comprises selecting the cooperative strategy for the relay node from the set of two or more cooperative strategies based on one or more channel quality based criteria.

31. The method of claim 21 wherein selecting the cooperative strategy for the relay node comprises selecting the cooperative strategy for the relay node from the set of two or more cooperative strategies based on a data rate based criterion.

32. The method of claim 21 wherein selecting the cooperative strategy for the relay node comprises selecting the cooperative strategy for the relay node from the set of two or more cooperative strategies based on a Signal-to-Interference plus Noise Ratio, SINR, based criterion.

33. The method of claim 21 wherein the two or more cooperative strategies comprise a first cooperative strategy that requires decoding of received messages and a second cooperative strategy that does not require decoding of received messages.

34. The method of claim 33 wherein the first cooperative strategy is a decode-and-forward cooperative strategy and the second cooperative strategy is one of a group consisting of: a compress-and-forward cooperative strategy and a short message noisy network coding cooperative strategy.

35. The method of claim 21 wherein the wireless network is a wireless mesh network.

36. The method of claim 35 wherein the wireless mesh network is a backhaul network between a plurality of access nodes of a cellular communications network, and the relay node is one of the plurality of access nodes.
